(19) United States
(12) Patent Application Publication
(10) Pub. No.: US 2007/0032594 A1
(43) Pub. Date: Feb. 8, 2007

(54) Self-crosslinking polyurethane dispersions containing uretdione and isocyanate-reactive groups

(75) Inventors: Jan Mazanek, Koln (DE); Jurgen Meixner, Krefeld (DE); Sebastian Dorr, Dusseldorf (DE); Olaf Fleck, Bergisch Gladbach (DE); Heino Muller, Leverkusen (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/496,294

(22) Filed: Jul. 31, 2006

(30) Foreign Application Priority Data
Aug. 4, 2005 (DE) 102005036654.6

(51) Int. Cl. C08G 18/08

(52) U.S. Cl. 524/589

(57) ABSTRACT

The present invention relates to aqueous, self-crosslinking polyurethane dispersions containing in the same polyurethane molecule structural units I) and II) 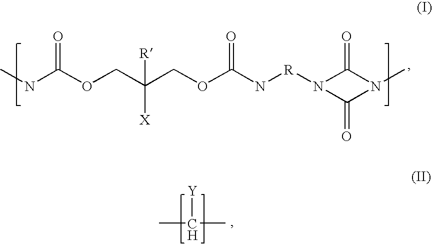 wherein R is the radical obtained by removing the isocyanate groups from an aliphatic, cycloaliphatic, araliphatic or aromatic polyisocyanate, R′ is an alkyl radical,
X is a carboxylic acid (COOH) or carboxylate (COO⁻) radical,
Y is NH₂, NHR″ or OH, and R″ is an alkyl radical. The present invention also relates to a process for preparing these aqueous, self-crosslinking polyurethane dispersions and to their use in aqueous one-component baking systems and in aqueous coating, varnishes or adhesive compositions.

### BACKGROUND OF THE INVENTION

1. Field of the Invention

The present invention relates to aqueous self-crosslinking polyurethane dispersions that are free of elimination products, to baking enamels produced therefrom and to their use in varnishes, coatings and adhesives.

2. Description of Related Art

Recent years have seen a sharp rise in the profile of aqueous paints and coating compositions in the wake of increasingly stringent emissions directives governing the solvents released during paint application. Although for many fields of application there are now aqueous coating compositions available, these systems are often unable to attain the high quality level of conventional, solvent-borne coating compositions with respect to solvent resistance and chemical resistance or elasticity and mechanical durability. In particular, there has been no disclosure to date of any polyurethane-based coating compositions that can be processed from the aqueous phase and that completely satisfy the exacting requirements of automotive OEM coatings.

This applies to DE-A 40 01 783, which deals with special anionically modified aliphatic polyisocyanates, and to the systems of DE-A 24 56 469, DE-A 28 14 815, EP-A 0 012 348 and EP-A 0 424 697, which describe aqueous binders for baking enamels based on blocked polyisocyanates and organic polyhydroxyl compounds. Additionally the systems based on carboxyl group-containing polyurethane prepolymers with blocked isocyanate groups of DE-A 27 08 611, and the blocked water soluble urethane prepolymers of DE-A 32 34 590, which have a high functionality and thus are largely unsuitable for producing elastic coatings, are to a large extent not useful for the stated purpose.

Further improvements have been made in recent years to the one-component (1K) baking enamels used, such as in EP-A 0 576 952, in which combinations of water soluble or water dispersible polyhydroxy compounds with water soluble or water dispersible blocked polyisocyanates are described, or in DE-A 199 30 555, which discloses combinations of a water dispersible, hydroxy-functional binder component containing urethane groups, a binder component which contains blocked isocyanate groups and is prepared in a multi-stage process over two prepolymerization steps, an amino resin and further components. A disadvantage of these one-component systems is that the components prepared in advance necessitate an additional mixing step.

The above, known 1K baking systems are based on blocked polyisocyanates, which eliminate the respective blocking agents when baked. DE-A 25 38 484 describes one-component dispersions in which a prepolymer is first prepared from hydroxyl-functional polyesters and polyisocyanates and is reacted with 30-70 equivalent % of diamines or diols, then hydrophilically modified and subsequently dispersed. The polyisocyanate employed is the uretdione of isophorone diisocyanate, optionally in admixture with isophorone diisocyanate and its trimers. In this 1K system there are two isocyanate groups, blocked in the form of uretdione groups, for each hydroxyl group. The hydroxyl groups are added during dispersion or subsequently.

The coating compositions described in the prior art do not, however, meet all of the requirements of the art, particularly not with respect to their stability or to the surface quality of the coatings produced from them, such as surface smoothness and gloss.

An object of the present invention is to provide improved 1K baking systems that can be used to prepare coatings having a relatively high solvent resistance.

This object has been achieved with the polyurethane dispersions of the present invention, which not only have uretdione groups but also isocyanate-reactive groups in the same molecule. Consequently, in addition to crosslinking between the polyurethane molecules, crosslinking within the polymer (intra-penetrating network) is also possible.

### SUMMARY OF THE INVENTION

The present invention relates to aqueous, self-crosslinking polyurethane dispersions containing in the same polyurethane molecule structural units I) and II) 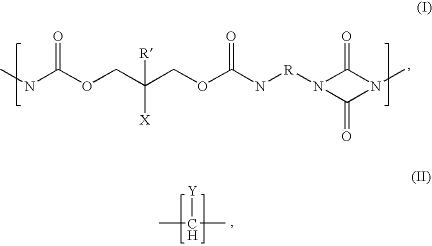
wherein
R is an aliphatic, cycloaliphatic, araliphatic or aromatic radical obtained by removing the isocyanate groups from a polyisocyanate selected from tetramethylene diisocyanate, cyclohexane 1,3- or 1,4-diisocyanate, hexamethylene diisocyanate (HDI), 1-isocyanato-3,3,5-trimethyl-5-isocyanatomethylcyclohexane (isophorone diisocyanate (IPDI), methylene bis-(4-isocyanatocyclohexane), tetramethylxylylene diisocyanate (TMXDI), triisocyanatononane, tolylene diisocyanate (TDI), diphenylmethane 2,4′- and/or 4,4′-diisocyanate (MDI), triphenylmethane 4,4′-diisocyanate and naphthylene 1,5-diisocyanate,
R′ is an alkyl radical,
X is a carboxylic acid (COOH) or carboxylate (COO⁻) radical,
Y is NH₂, NHR″ or OH, and
R″ is an alkyl radical.

The present invention also relates to a process for preparing the aqueous, self-crosslinking polyurethane dispersions of the invention by
I) preparing in a first step an ionic hydrophilic prepolymer containing hydroxyl or isocyanate end groups by reacting
   a) one or more polyisocyanates A1) having an NCO functionality of ≧2,
   b) at least one compound C) containing at least one isocyanate-reactive group and one acid-functional group,
   c) optionally a polyol component B1) having a hydroxyl group functionality of ≧2 and a number average molecular weight Mₙ of 62 to 500,
II) preparing in a second step a prepolymer containing uretdione groups, which is terminated with isocyanate groups, by reacting
   d) at least one polyisocyanate component A2) which contains uretdione groups and has an NCO functionality of ≧2 and a ratio of uretdione groups to isocyanate groups of at least 0.10,
   e) one or more polyol components B2) having a hydroxyl group functionality of ≧1, and
   f) optionally polyisocyanates A1) which have an NCO functionality of ≧2, and
III) reacting in a third step the prepolymer obtained in the second step with
   g) at least one polyol component (B3) having an average hydroxyl group functionality of ≧2 and a number average molecular weight Mₙ of 500 to 5000,
      to form an isocyanate-free and hydroxyl-functional polyurethane polymer, dispersing the polyurethane polymer in water and at least partially neutralizing the polyurethane polymer with a neutralizing agent N) either before, during or after dispersing the polyurethane polymer is water.

The present invention also relates to aqueous one-component baking systems containing the polyurethane dispersions of the invention.

The present invention also relates to aqueous coating, varnishes or adhesive compositions containing the polyurethane dispersions of the invention.

### DETAILED DESCRIPTION OF THE INVENTION

In the polyurethane dispersions of the invention the polyurethane contains uretdione groups, which function as blocked isocyanate groups, and also hydroxyl or amino groups in one molecule. In accordance with the present invention first two synthesis steps may be conducted in reverse order or they may be combined into a single reaction step. A further possibility is to use a portion of compound C) in the second step when reacting the polyisocyanate mixture containing uretdione groups.

In structural units I) and II)
R is an aliphatic, cycloaliphatic, araliphatic or aromatic radical obtained by removing the isocyanate groups from a polyisocyanate selected from tetramethylene diisocyanate, cyclohexane 1,3- or 1,4-diisocyanate, hexamethylene diisocyanate (HDI), 1-isocyanato-3,3,5-trimethyl-5-isocyanatomethylcyclohexane (isophorone diisocyanate IPDI), methylene bis-(4-isocyanatocyclohexane), tetramethylxylylene diisocyanate (TMXDI), triisocyanatononane, tolylene diisocyanate (TDI), diphenylmethane 2,4′- and/or 4,4′-diisocyanate (MDI), triphenylmethane 4,4′-diisocyanate and naphthylene 1,5-diisocyanate,
R′ is an alkyl radical, preferably ethyl or methyl, and more preferably methyl,
X is a carboxylic acid (COOH) or carboxylate (COO⁻) radical,
Y is NH₂, NHR″ or OH, preferably OH, and
R″ is an alkyl radical, preferably hexyl, butyl, propyl, ethyl or methyl, and more preferably methyl.

In one preferred embodiment of the invention, an acid-functional compound C) and a polyisocyanate component A1) are added either at the same time or after the addition of polyol component B3).

In the process of the invention the equivalent ratio of the isocyanate groups, including the uretdione groups, to all isocyanate-reactive groups is 0.5 to 5.0:1, preferably 0.6 to 2.0: , and more preferably 0.8 to 1.5:1.

Suitable polyisocyanates A1) include aliphatic, cycloaliphatic, araliphatic and/or aromatic isocyanates having an average functionality of 2 to 5, preferably 2, and having an isocyanate content of 0.5% to 60%, preferably 3% to 40%, and more preferably 5% to 30%, by weight. Examples include tetramethylene diisocyanate, cyclohexane 1,3- or 1,4-diisocyanate, hexamethylene diisocyanate (HDI), 1-isocyanato-3,3,5-trimethyl-5-isocyanatomethylcyclohexane (isophorone diisocyanate IPDI), methylene bis-(4-isocyanatocyclohexane), tetramethylxylylene diisocyanate (TMXDI), triisocyanatononane, tolylene diisocyanate (TDI), diphenylmethane 2,4′- and/or 4,4′-diisocyanate (MDI), triphenylmethane 4,4′-diisocyanate, naphthylene 1,5-diisocyanate, and mixtures of these isocyanates. Preferred are isophorone diisocyanate, bis-(4-isocyanatocyclohexyl) methane or hexamethylene diisocyanate.

Additionally suitable are low molecular weight polyisocyanates containing urethane groups, which may be obtained by reacting an excess of a monomeric polyisocyanate, preferably TDI or IPDI, with monomeric polyhydric alcohols having a number average molecular weight of 62 to 300, preferably trimethylolpropane or glycerol.

Suitable polyisocyanates A1) also include the known NCO prepolymers containing terminal isocyanate groups and obtained by reacting the above-mentioned monomeric polyisocyanates, especially diisocyanates, with substoichiometric amounts of organic compounds containing at least two isocyanate-reactive groups, preferably hydroxyl groups, and having a number average molecular weight of >300. In these known prepolymers the ratio of isocyanate groups to NCO-reactive groups is 1.05:1 to 10:1, preferably 1.5:1 to 4:1. The functionality and amounts of the starting materials used in preparing the NCO prepolymers are selected such that the NCO prepolymers preferably have an average NCO functionality of 2 to 3 and a number average molecular weight of 500 to 10,000, preferably 800 to 4000.

Suitable polyisocyanates A2) are those containing at least one isocyanate group and at least one uretdione group. They are prepared, as described for example in WO-A 02/92657 or WO-A 2004/005364, by reacting suitable starting isocyanates. During this reaction, which is preferably catalyzed with catalysts, such as triazolates or 4-dimethylaminopyridine (DMAP), a portion of the isocyanate groups is converted into uretdione groups. Examples of suitable polyisocyanates for preparing the uretdione-containing polyisocyanates (A2) include tetramethylene diisocyanate, cyclohexane 1,3- or 1,4-diisocyanate, hexamethylene diisocyanate (HDI), 1-isocyanato-3,3,5-trimethyl-5-isocyanatomethylcyclohexane (isophorone diisocyanate IPDI), methylene bis-(4-isocyanatocyclohexane), tetramethylxylylene diisocyanate (TMXDI), triisocyanatononane, tolylene diisocyanate (TDI), diphenylmethane 2,4′- and/or 4,4′-diisocyanate (MDI), triphenylmethane 4,4′-diisocyanate, naphthylene 1,5-diisocyanate, and mixtures thereof. Preferred are isophorone diisocyanate, bis-(4-isocyanatocyclohexyl)-methane or hexamethylene diisocyanate.

Polyol component B 1) is selected from divalent to hexavalent polyols having a molecular weight Mₙ of 62 to 500, preferably 62 to 400, and more preferably 62 to 300. Examples of preferred polyol components B 1) include 1,4- and/or 1,3-butanediol, 1,6-hexanediol, 2,2,4-trimethyl-1,3-pentanediol, trimethylolpropane, and polyester polyols and polyether polyols having a molecular weight Mₙ of less than or equal to 500.

Suitable acid-functional compounds C) include hydroxyl-functional carboxylic acids, preferably monohydroxy and dihydroxy carboxylic acids, such as 2-hydroxyacetic acid, 3-hydroxypropanoic acid or 12-hydroxy-9-octadecanoic acid (ricinoleic acid). Preferred carboxylic acids C) are those in which the carboxyl group is sterically hindered, such as lactic acid. Particularly preferred is 3-hydroxy-2,2-dimethylolpropanoic acid (hydroxypivalic acid) or dimethylolpropionic acid. Most preferably dimethylolpropionic acid is exclusively used.

If component B1) is used in step I), it is used in an amount of less than 50% by weight, based on the weight of components C) and B1). It is preferred in step I) to exclusively use component C).

Polyol component B2) is selected from
b1) dihydric to hexahydric alcohols having number average molecular weights Mₙ of 62 to 300, preferably 62 to 182, and more preferably 62 to 118,
b2) linear, difunctional polyols having number average molecular weights Mₙ of 350 to 4000, preferably 350 to 2000, and more preferably 350 to 1000, and
b3) monofunctional linear polyethers having number average average molecular weights Mₙ of 350 to 2500, preferably of 500 to 1000.

Suitable polyols b1) include dihydric to hexahydric alcohols and/or mixtures thereof which contain no ester groups. Examples include ethane-1,2-diol, propane-1,2- and -1,3-diol, butane-1,4-, -1,2- or -2,3-diol, hexane-1,6-diol, 1,4-dihydroxycyclohexane, glycerol, trimethylolethane, trimethylolpropane, pentaerythritol and sorbitol. It will be appreciated that as component b1) it is also possible to use alcohols having ionic groups or groups which can be converted into ionic groups. Preference is given, for example, to 1,4- or 1,3-butanediol, 1,6-hexanediol, trimethylolpropane and mixtures thereof.

Suitable linear difunctional polyols b2) are selected from polyethers, polyesters and/or polycarbonates. Polyol component b2) preferably contains at least one diol which contains ester groups and has a number average molecular weight Mₙ of 350 to 4000, preferably 350 to 2000, more preferably 350 to 1000. These number average molecular weight can be calculated from the hydroxyl number. The ester diols are mixtures of diols, in which individual diol molecules are present that have a molecular weight situated above or below the preceding limits.

The polyester diols are known and may be synthesized from diols and dicarboxylic acids. Examples of suitable diols include 1,4-dimethylolcyclohexane, 1,4- or 1,3-butanediol, 1,6-hexanediol, neopentyl glycol, 2,2,4-trimethyl-1,3-pentanediol, trimethylolpropane, pentaerythritol or mixtures thereof. Examples of suitable dicarboxylic acids include aromatic dicarboxylic acids such as phthalic acid, isophthalic acid and terephthalic acid; cycloaliphatic dicarboxylic acids such as hexahydrophthalic acid, tetrahydrophthalic acid, endomethylenetetrahydrophthalic acid and/or their anhydrides; and preferably aliphatic dicarboxylic acids such as succinic acid, glutaric acid, adipic acid, suberic acid, azelaic acid, sebacic acid or their anhydrides.

Polyester diols based on adipic acid, phthalic acid, isophthalic acid or tetrahydrophthalic acid are preferably used as component b2). Preferred diols are 1,4- or 1,3-butanediol, 1,6-hexanediol, trimethylolpropane and mixtures thereof.

Also suitable as component b2) are polycaprolactone diols having a number average molecular weight of 350 to 4000, preferably 350 to 2000, and more preferably from 350 to 1000. These diols may be prepared in conventional manner from a diol or diol mixture of the type exemplified above, as starter and ε-caprolactone. The preferred starter molecule is 1,6-hexanediol. Particularly preferred are polycaprolactone diols prepared by polymerizing ε-caprolactone using 1,6-hexanediol as starter.

Linear polyol component b2) also includes polyethers of ethylene oxide, propylene oxide and/or tetrahydrofuran. Preferred polyethers are those having a number average molecular weight Mₙ of 500 to 2000, such as polyethylene oxides or polytetrahydrofuran diols.

Also suitable as component b2) are hydroxyl-containing polycarbonates, preferably having a number average molecular weight Mₙ of 400 to 4000, preferably 400 to 2000, such as hexanediol polycarbonate and also polyester carbonates.

Suitable monofunctional linear polyethers b3) include polyethers of ethylene oxide and/or propylene oxide. Preferred are polyalkylene oxide polyethers prepared from monoalcohols, having a number average molecular weight Mₙ of 350 to 2500, preferably 500 to 1000, and containing at least 70 weight-%, preferably more than 75 weight-% of ethylene oxide units. Preferred starter molecules for preparing these polyethers are monofunctional alcohols having 1 to 6 carbon atoms.

Suitable polyols (B3) are branched polyols having an OH functionality of greater than or equal to 2, and having number average molecular weights of 500 to 5000, preferably 500 to 3000, more preferably 500 to 2000.

Preferred polyols (B3) include polyethers having a number average molecular weight of 300 to 2000 and an average functionality of 2.5 to 4 OH groups/molecule. Also preferred are polyesters having an average OH functionality of 2.5 to 4.0. Suitable diols and dicarboxylic acids for the polyesters are those set forth under component b2), and also trifunctional to hexafunctional short chain polyols, such as trimethylolpropane, pentaerythritol or sorbitol. It is preferred to use polyester polyols prepared from adipic acid, phthalic acid, isophthalic acid or tetrahydrophthalic acid and trimethylolpropane, butane-1,4-diol or hexane-1,6-diol.

Also suitable as component B3) are polyethers of ethylene oxide, propylene oxide and/or tetrahydrofuran having an average functionality of greater than or equal to 2, and also branched polycarbonates.

The process of the invention is carried out such that during the reaction of components A) and B1) in accordance with the theoretical stoichiometric equation there is as little as possible unreacted excess components A) and/or B1) present.

The preparation of the aqueous dispersions containing the self-crosslinking polyurethanes of the invention takes place in accordance with prior-art processes.

At least 50%, preferably 80% to 120%, and more preferably 95% to 105%, of the carboxylic acid groups present in the polyurethanes of the invention are neutralized using suitable neutralizing agents N) and then dispersed using deionized water. Neutralization may take place before, during or after the dispersing or dissolving step. Preferably, neutralization takes place prior to the addition of water.

Suitable neutralizing agents N) include triethylamine, dimethylaminoethanol, dimethylcyclohexylamine, triethanolamine, methyldiethanolamine, diisopropanolamine, ethyldiisopropylamine, diisopropylcyclohexylamine, N-methylmorpholine, 2-amino-2-methyl-1-propanol, ammonia, other known neutralizing agents or mixtures thereof.

Preferred are tertiary amines such as triethylamine and diisopropylhexylamine. Particularly preferred is dimethylethanolamine.

To regulate the viscosity it is possible to optionally add solvents to the reaction mixture. Suitable solvents include the known paint solvents, such as N-methylpyrrolidone, methoxypropyl acetate, Proglyde® MM (Dow Chemicals), Shellsol® (Shell AG) or xylene. It is preferred to use amounts of 0 to 10% by weight, preferably 0 to 5% by weight. The solvent is preferably added during the polymerization. Catalysts may also be added to the reaction mixture, preferably dibutyltin dilaurate or dibutyltin octoate.

The dispersions of the invention are used as one-component baking systems, containing free hydroxyl groups, for preparing varnishes, paints, adhesives and other formulations. Additives from coatings technology can optionally be used, such as pigments, flow-control agents, additives for preventing bubbles or blisters, or catalysts, can also be added to the aqueous dispersions of the invention.

The aqueous one-component coating compositions containing the dispersions of the invention can be applied by any of the known methods of coatings technology, such as spraying, spreading, dipping, flow coating, or using rollers and coating knives, to any desired, heat-resistant substrates in one or more coats. The coating films generally have a dry film thickness of 0.001 to 0.3 mm. Examples of suitable substrates include metal, plastic, wood and glass. Curing of the coating film takes place at 80 to 220° C., preferably at 130 to 180° C.

The aqueous one-component coating compositions containing the polyurethane dispersions of the invention are especially suitable for the production of coatings and paint systems on steel sheets such as those used for producing vehicle bodies, machines, panelling, drums or freight containers. Particularlly preferred are aqueous one-component coating compositions containing the polyurethane dispersions of the invention for preparing automotive surfacers and/or topcoat materials.

The invention is further illustrated but is not intended to be limited by the following examples in which all parts and percentages are by weight unless otherwise specified.

### EXAMPLES

Desmodur® Z 4470 M/X:

Aliphatic polyisocyanate prepared from isophorone diisocyanate, present as a 70% solution in a mixture of methoxypropyl acetate and xylene (1/1), isocyanate content approximately 12%, and available from Bayer Material Science AG, Leverkusen, DE

Additol XW 346:

Flow-control assistant/defoamer, available from UCB Chemicals, St. Louis, USA

Unless noted otherwise, all analytical measurements relate to temperatures of 23° C.

The reported viscosities were determined by means of rotational viscometry in accordance with DIN 53019 at 23° C. using a rotational viscometer from Anton Paar Germany GmbH, Ostfildern, DE.

Unless expressly indicated otherwise, NCO contents were determined volumetrically in accordance with DIN EN ISO 11909.

The reported particle sizes were determined by means of laser correlation spectroscopy (instrument: Malvern Zetasizer 1000, Malvern Instr. Limited).

The solids contents were determined by heating a weighed sample at 120° C. When constant weight was reached, the solids content was calculated by weighing the specimen again.

Monitoring for free NCO groups was carried out by means of IR spectroscopy (band at 2260 cm⁻¹).

### Example 1

### Preparation of A Uretdione Prepolymer From IPDI

1000 g (4.50 mol) of isophorone diisocyanate (IPDI) were admixed with 20 g (2%) of 4-dimethylaminopyridine (DMAP) as catalyst at room temperature under dry nitrogen and with stirring. After 24 h the reaction mixture, which had an NCO content of 27.2%, corresponding to a degree of oligomerization of 26.5%, was freed from volatile constituents using a thin-film evaporator at a temperature of 160° C. and a pressure of 0.3 mbar, without prior addition of a catalyst poison. A highly viscous uretdione polyisocyanate was obtained which was pale yellow in color and having a free NCO group content of 16.8% and a monomeric IPDI content of 0.3%. According to the product's ¹³C NMR spectrum it was free from isocyanurate groups.

### Example 2

### Inventive

A solution of 26.83 g (0.4 eq OH) of dimethylolpropionic acid in 53.66 g of N-methylpyrrolidone was admixed at 50° C. with 33.36 g (0.3 eq NCO) of isophorone diisocyanate. The mixture was then stirred at 85° C. until NCO groups were no longer detected by IR spectroscopy (about 3 hours). Thereafter 141.97 g (0.6 eq NCO) of the compound from Example 1, 72.00 g (0.4 eq NCO) of Desmodur® Z 4470 M/X (Bayer AG, Leverkusen), 12.50 g (0.025 eq OH) of a polyethylene oxide prepared starting from methanol and having a number average molecular weight of 500, and 189.00 g (0.45 eq OH) of a polyester prepared from adipic acid and 1,6-hexanediol and having a number average molecular weight of 840 were added and the mixture was stirred at 85° C. until an NCO content of 1.65% (calc.: 1.79%) was attained (about 4 hours). The batch was then cooled to 65° C. and diluted with 27 g of N-methylpyrrolidone and 119 g of acetone. Following the addition of 318.18 g (1.0 eq OH) of a polyester prepared from adipic acid, isophthalic acid, trimethylolpropane, neopentyl glycol and propylene glycol, and 13.41 g (0.20 eq OH) of dimethylolpropionic acid and 44.48 g (0.4 eq NCO) of isophorone diisocyanate, the mixture was stirred at 65° C. until NCO groups were no longer detected by IR spectroscopy (about 3 hours). 860 g of acetone and 23.40 g (0.525 mol) of dimethylethanolamine were added, the mixture was stirred for 10 minutes, then 858 g of deionized water were added with stirring, and the acetone was distilled off under reduced pressure (finally at 40° C./120 mbar).

The resulting dispersion had the following properties:

| | |
|---|---|
| Solids content: | 42% |
| pH value: | 7.60 |
| Viscosity (Haake rotational | 80 mPas |
| viscometer, 23° C.) | |
| Particle size (laser correlation | 85 nm |
| spectroscopy, LCS) | |

In the case of Comparative Example 1 the procedure adopted was exactly the same as that in the inventive Example, but at the end of formation of the prepolymer a stoichiometrie amount of the alcohol component of a polyester prepared from adipic acid, isophthalic acid, trimethylolpropane, neopentyl glycol and propylene glycol was added. This resulted in hydroxyl-free crosslinker molecules. A polyhydroxy component for crosslinking in the coating composition should (as in the case of the literature examples EP-A 0 576 952 or DE 25 38 484) not to be added until after the conclusion of prepolymer formation or until after dispersion. The reaction mixture, however, became solid even before the addition of the polyhydroxy component after prepolymer formation, and even after the further addition of solvent (500 g of acetone) could not be dissolved or dispersed.

### Example 3

### Comparative Example

A solution of 26.83 g (0.4 eq OH) of dimethylolpropionic acid in 53.66 g of N-methylpyrrolidone was admixed at 50° C. with 33.36 g (0.3 eq NCO) of isophorone diisocyanate. The mixture was then stirred at 85° C. until NCO groups were no longer detected by IR spectroscopy (about 3 hours). Thereafter 141.97 g (0.6 eq NCO) of compound from Example 1, 72.00 g (0.4 eq NCO) of Desmodur® Z 4470 M/X (Bayer AG, Leverkusen), 12.50 g (0.025 eq OH) of a polyethylene oxide prepared starting from methanol and having a number average molecular weight of 500, and 189.00 g (0.45 eq OH) of a polyester prepared from adipic acid and 1,6-hexanediol and having an average molecular weight of 840 were added and the mixture was stirred at 85° C. until an NCO content of 1.65% (calc.: 1.79%) was attained (about 4 hours). The batch was then cooled to 65° C. and diluted with 27 g of N-methylpyrrolidone and 119 g of acetone. Following the addition of 166.75 g (0.45 eq OH) of a polyester prepared from adipic acid, isophthalic acid, trimethylolpropane, neopentyl glycol and propylene glycol, and 13.41 g (0.20 eq OH) of dimethylolpropionic acid and 44.48 g (0.4 eq NCO) of isophorone diisocyanate, the mixture was stirred at 65° C. until NCO groups were no longer detected by IR spectroscopy (about 3 hours). At this point the reaction mixture solidified and could no longer be dissolved even by the further addition of acetone (500 g). 860 g of acetone and 23.40 g (0.525 mol) of dimethylethanolamine were added, the mixture was stirred for 10 minutes, then 858 g of deionized water were added with stirring—at this point there was neither dissolution of the solids nor formation of a dispersion.

### APPLICATIONS SECTION

A clearcoat material having the composition below was prepared. The clearcoat materials were used to produce films, which were dried at room temperature for 10 minutes and then baked at 160° C. for 30 minutes. The films obtained were subjected to performance assessment. The results are set forth in the table below.

TABLE 1
Performance test

Example No.

| | 4 | 5 |
|---|---|---|
| Compound from Example | 2 | 3 |
| Product | 150.0 | 150.0 |
| Byk ® 346, as-supplied form | 0.8 | 0.8 |
| DMEA, 10% strength in water | 3.4 | 3.4 |
| Distilled water | — | — |
| Total | 154.2 | 154.2 |
| Solids (%) | 39.5 | (4) |
| Flow time ISO 5 mm [s] (3) | 28 | (4) |
| pH (at 23° C.) | 8.3 | (4) |
| Baking conditions: | | |
| 10 min. RT + 30 min. 160° C. | | |
| Appearance of coating composition | satisfactory | (5) |
| (inspection) | | |
| Pendulum hardness [s] (2) | 137 | (5) |
| Incipient dissolubility 1 minute [0-5] | 1144 | (5) |
| (1) | | |

(1) 1 minute - sequence of the solvents: xylene/methoxypropyl acetate/ethyl acetate/acetone. Assessment: 0 - very good to 5 - poor.
(2) The pendulum hardness was measured by the König method in accordance with DIN 53157.
(3) The flow time was determined in a cup in accordance with DIN 53 211.
(4) Value not determined since coating composition could not be prepared.
(5) Value not determined since coating could not be prepared.

The results of the performance testing demonstrates that the coating composition prepared from inventive dispersion 2 meets the requirements in terms of flow, hardness and solvent resistance. From the values for film hardness and solvent resistance it is possible to recognize the crosslinking of the hydroxyl groups with the uretdione groups; a blocking agent is not released.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. An aqueous, self-crosslinking polyurethane dispersions containing in the same polyurethane molecule structural units I) and II) 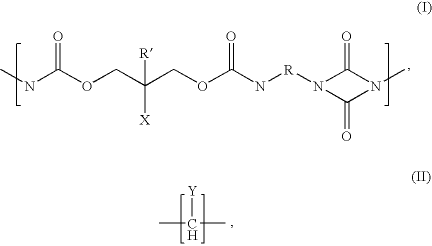
wherein
R is an aliphatic, cycloaliphatic, araliphatic or aromatic radical obtained by removing the isocyanate groups from a polyisocyanate comprising a member selected from the group consisting of tetramethylene diisocyanate, cyclohexane 1,3-diisocyanate, cyclohexane 1,4-diisocyanate, hexamethylene diisocyanate, 1-isocyanato-3,3,5-trimethyl-5-isocyanatomethylcyclohexane, methylene bis-(4-isocyanatocyclohexane), tetramethylxylylene diisocyanate, triisocyanatononane, tolylene diisocyanate, diphenylmethane 2,4′-diisocyanate, diphenylmethane 4,4′-diisocyanate, triphenylmethane 4,4′-diisocyanate and naphthylene 1,5-diisocyanate,
R′ is an alkyl radical,
X is a carboxylic acid (COOH) or carboxylate (COO⁻) radical,
Y is NH₂, NHR″ or OH, and
R″ is an alkyl radical.

2. A process for preparing the polyurethane dispersions of claim 1 which comprises
I) preparing in a first step an ionic hydrophilic prepolymer containing hydroxyl or isocyanate end groups by reacting
a) one or more polyisocyanates A1) having an NCO functionality of ≧2,
b) at least one compound C) containing at least one isocyanate-reactive group and one acid-functional group,
c) optionally a polyol component B1) having a hydroxyl group functionality of ≧2 and a number average molecular weight Mₙ of 62 to 500,
II) preparing in a second step a prepolymer containing uretdione groups, which is terminated with or isocyanate groups, by reacting
d) at least one polyisocyanate component A2) which contains uretdione groups and has an NCO functionality of ≧2 and a ratio of uretdione groups to isocyanate groups of at least 0.10,
e) one or more polyol components B2) having a hydroxyl group functionality of ≧1, and
f) optionally polyisocyanates A1) which have an NCO functionality of ≧2, and
III) reacting in a third step the prepolymer obtained in the second step with
g) at least one polyol component (B3) having an average hydroxyl group functionality of ≧2 and a number average molecular weight Mₙ of 500 to 5000,
to form an isocyanate-free and hydroxyl-functional polyurethane polymer, dispersing the polyurethane polymer in water and at least partially neutralizing the polyurethane polymer with a neutralizing agent N) either before, during or after dispersing the polyurethane polymer is water.

3. The process of claim 2 which comprises adding an acid-functional compound C) and a polyisocyanate component A1) either at the same time or after the addition of polyol component B3).

4. The process of claim 2 wherein the equivalent ratio of the isocyanate groups, including the uretdione groups, to all the isocyanate-reactive groups of 0.5 to 5.0:1.

5. The process of claim 2 wherein component A2) comprises a uretdione group-containing polyisocyanate prepared from from isophorone diisocyanate, bis(4,4-isocyanatocyclohexylmethane) or hexamethylene diisocyanate.

6. The process of claim 2 wherein component C) comprises 3-hydroxy-2,2-dimethylolpropanoic acid or dimethylolpropionic acid.

7. The process of claim 2 wherein component C) comprises dimethylolpropionic acid.

8. An aqueous coating, varnish or adhesive composition containing the aqueous, self-crosslinking polyurethane dispersion of claim 1.

9. An aqueous one-component baking system containing the aqueous, self-crosslinking polyurethane dispersion of claim 1.
